(19) United States
(12) Patent Application Publication
(10) Pub. No.: US 2015/0323732 A1
(43) Pub. Date: Nov. 12, 2015

(54) LIGHT FLUX CONTROLLING MEMBER, LIGHT EMITTING DEVICE, SURFACE LIGHT SOURCE DEVICE AND DISPLAY APPARATUS

(71) Applicant: Enplas Corporation, Saitama (JP)

(72) Inventors: Yusuke OHASHI, Saitama (JP); Masao YAMAGUCHI, Saitama (JP)

(21) Appl. No.: 14/704,134

(22) Filed: May 5, 2015

(30) Foreign Application Priority Data
May 7, 2014 (JP) 2014-095870

(51) Int. Cl. F21V 8/00

(52) U.S. Cl. CPC G02B 6/0068; G02B 6/0051; G02B 6/0073; G02B 6/0031

(57) ABSTRACT

A light flux controlling member includes: a rear surface; an incidence surface configured such that light emitted from a light emitting element is incident on the incidence surface, the incidence surface being the inner surface of a recess opened at the rear surface; a reflection surface configured to laterally reflect part of the light incident on the incidence surface; and an emission surface configured to emit the light reflected by the reflection surface, the emission surface being disposed to surround the central axis. The incidence surface includes a top surface and a side surface. The side surface includes a plurality of linear protrusions each including a ridge line extending from the outer rim part of the top surface to the opening edge of the recess.

### CROSS REFERENCE TO RELATED APPLICATIONS

This application is entitled to and claims the benefit of Japanese Patent Application No. 2014-095870, filed on May 7, 2014, the disclosure of which including the specification, drawings and abstract is incorporated herein by reference in its entirety.

### TECHNICAL FIELD

The present invention relates to a light flux controlling member configured to control the distribution of light emitted from a light emitting element. Further, the present invention relates to a light emitting device, surface light source device and display apparatus which include the light flux controlling member.

### BACKGROUND ART

Some transmission type image display apparatuses such as liquid crystal display apparatuses use a backlight (direct surface light source device). In recent years, backlights having a plurality of light emitting elements as the light source have been used.

A backlight has, for example, a substrate, a plurality of light emitting elements, a plurality of light flux controlling members and a light diffusion member. The plurality of light emitting elements are disposed in a matrix on the substrate. Over each light emitting element, the light flux controlling member is disposed for expanding light emitted from each light emitting element in the plane direction of the substrate. The light emitted from the light flux controlling member is diffused by the light diffusion member, and planarly illuminates a member to be irradiated (e.g. a liquid crystal panel) (see, for example, PTL 1).

A backlight (surface light source device) disclosed in PTL 1 includes a casing, a substrate disposed in the casing, a light emitting element disposed on the substrate, a light guide member (light flux controlling member) disposed on the substrate to cover the light emitting element so as to control the distribution of light emitted from the light emitting element, and a light diffusion member which allows light emitted from the light guide member to pass therethrough while diffusing the light. The light guide member includes an incidence surface on which the light emitted from the light emitting element is incident, a reflection surface facing away from the incidence surface and configured to reflect the incident light laterally, and an emission surface configured to emit the light reflected by the reflection surface.

Light emitted from the light emitting element enters the light guide member from the incidence surface. The light entered the light guide member is reflected laterally by the reflection surface and emitted toward the outside of the light guide member from the emission surface.

### CITATION LIST

### Patent Literature

### PTL 1

### Japanese Patent Application Laid-Open No. 2011-039122

### SUMMARY OF INVENTION

### Technical Problem

In the backlight disclosed in PTL 1, although most of the light emitted from the light emitting element directly enters the light guide member from the incidence surface, occasionally part of the light emitted from the light emitting element is reflected by the incidence surface. In this case, the light reflected by the incidence surface enters the light guide member from another place of the incidence surface. When light is reflected by the incidence surface in such a manner, the light deviates from the intended optical path and may become stray light travelling to a portion immediately above the light emitting element. As seen from the above, the backlight disclosed in PTL 1 has the drawback of forming a bright part over the light diffusion member due to the stray light.

An object of the present invention is to provide a light flux controlling member capable of suppressing the formation of a bright part in a portion immediately above the light flux controlling member.

Another object of the present invention is to provide a light emitting device, surface light source device and display apparatus which include the light flux controlling member.

### Solution to Problem

In order to achieve the aforementioned objects, a light flux controlling member according to the present invention configured to control the distribution of light emitted from a light emitting element includes: a rear surface disposed on a rear side of the light flux controlling member; an incidence surface configured such that light emitted from the light emitting element is incident on the incidence surface, the incidence surface being an inner surface of a recess opened at the rear surface to intersect the central axis of the light flux controlling member; a reflection surface configured to laterally reflect part of the light incident on the incidence surface, the reflection surface being disposed on the front side of the light flux controlling member so that the distance from the light emitting element to the reflection surface increases in the direction from the center to the outer periphery of the reflection surface; and an emission surface configured to emit the light reflected by the reflection surface, the emission surface being disposed to surround the central axis; wherein the incidence surface comprises: a top surface disposed in the recess so as to intersect the central axis, a side surface connecting the outer rim part of the top surface with the opening edge of the recess, wherein the side surface comprises a plurality of linear protrusions each including a ridge line extending from the outer rim part of the top surface to the opening edge of the recess.

In order to achieve the aforementioned objects, a light emitting device according to the present invention includes: the light emitting element and the light flux controlling member according to the present invention, wherein the light flux controlling member is disposed such that the central axis coincides with the optical axis of the light emitting element.

In order to achieve the aforementioned objects, a surface light source device according to the present invention includes: the light emitting device according to the present invention, and a light diffusion member configured to allow light emitted from the light emitting device to pass through the light diffusion member while diffusing the light.

In order to achieve the aforementioned objects, a display apparatus according to the present invention includes: the surface light source device according to the present invention, and a display member configured such that light emitted from the surface light source device is radiated to the display member.

### Advantageous Effects of Invention

A light flux controlling member according to the present invention and a light emitting device including the light flux controlling member can suppress the formation of a bright part in a portion immediately thereabove. Therefore, a surface light source device and display apparatus according to the present invention can reduce luminance unevenness compared to the conventional devices.

### BRIEF DESCRIPTION OF DRAWINGS

FIGS. 1A and 1B are outer appearance views illustrating a configuration of a surface light source device according to an embodiment;

FIGS. 2A and 2B are cross-sectional views illustrating the configuration of the surface light source device according to the embodiment;

FIG. 3 is a partially enlarged cross-sectional view of an enlarged part of FIG. 2B;

FIGS. 4A to 4C illustrate a configuration of a light flux controlling member according to the embodiment;

FIGS. 5A and 5B show a relationship between optical paths and the height of a side surface in a comparative example;

FIGS. 6A to 6D show a relationship between optical paths and an emission angle in the comparative example;

FIGS. 7A and 7B each show a simulation of optical paths in the light flux controlling member according to the embodiment;

FIGS. 8A and 8B each show a simulation of optical paths in the light flux controlling member according to the embodiment;

FIGS. 9A and 9B each show a simulation of optical paths in the light flux controlling member according to the embodiment; and

FIGS. 10A and 10B illustrate optical paths in the light flux controlling member and 10C illustrates plotted arrival positions of light on a light diffusion member.

### DESCRIPTION OF EMBODIMENTS

Hereinafter, embodiments of the present invention will be described in detail with reference to the accompanying drawings. In the following description, as representative examples of surface light source devices according to the present invention, surface light source devices suitable for backlights of liquid crystal display apparatuses or the like will be described. These surface light source devices may be used as display apparatuses in combination with members to be irradiated (e.g. liquid crystal panels) to which light from the surface light source devices is radiated.

(Configurations of Surface Light Source Device and Light Emitting Device)

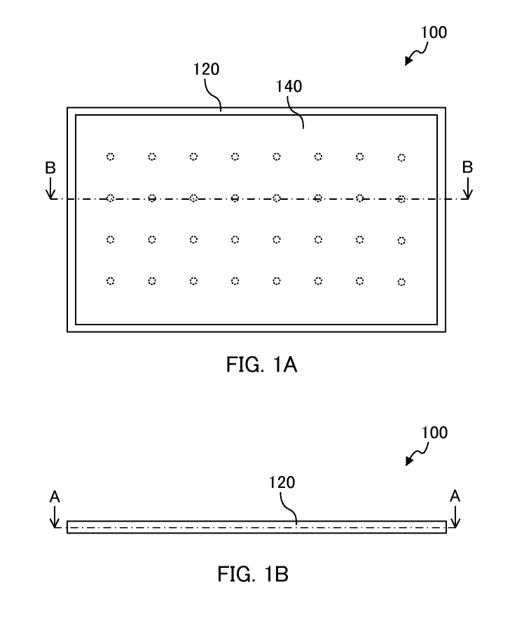

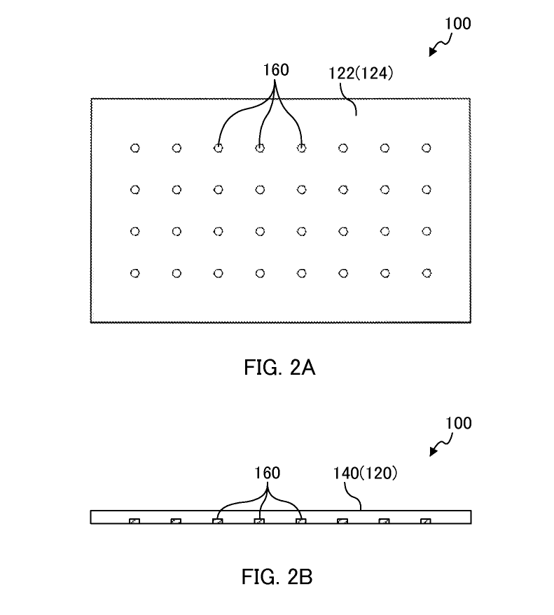

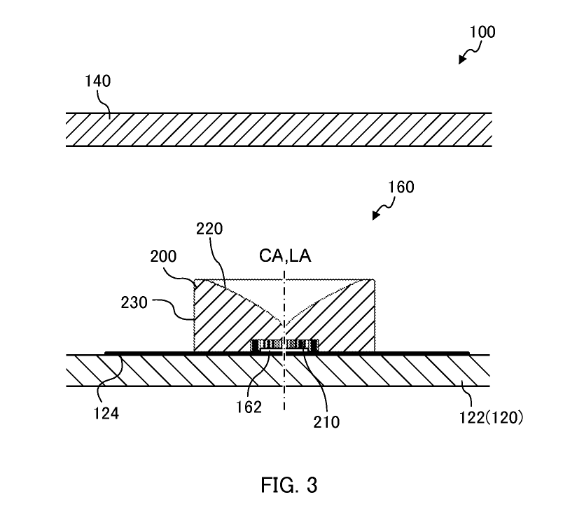

FIGS. 1A to 3 illustrate a configuration of surface light source device 100 according to an embodiment of the present invention. FIG. 1A is a plan view and FIG. 1B is a front view of surface light source device 100 according to the present embodiment. FIG. 2A is a cross-sectional view taken along line A-A shown in FIG. 1B, and FIG. 2B is a cross-sectional view taken along line B-B shown in FIG. 1A. FIG. 3 is a partially enlarged cross-sectional view of an enlarged part of FIG. 2B.

As illustrated in FIGS. 1A to 2B, surface light source device 100 according to the present embodiment includes casing 120, light diffusion member 140, and a plurality of light emitting devices 160. Light emitting devices 160 are disposed in a matrix on bottom plate 122 of casing 120. The inner surface of bottom plate 122 functions as a diffusion and reflection surface. Further, the top plate of casing 120 has an opening. Light diffusion member 140 is disposed so as to cover the opening, and functions as a light emitting surface. The size of the light emitting surface is, for example but not limited to, about 400 mm in height and about 700 mm in width (32 inch).

As illustrated in FIG. 3, each of light emitting devices 160 is fixed to each of substrates 124. Each of substrates 124 is fixed on bottom plate 122 of casing 120 at a predetermined position. Each of light emitting devices 160 comprises light emitting element 162 and light flux controlling member 200.

Light emitting element 162 is a light source of surface light source device 100, and mounted on substrate 124. Light emitting element 162 is a light emitting diode (LED) such as a white light emitting diode.

Light flux controlling member 200 is a diffusion lens configured to control the distribution of light emitted from light emitting element 162, and fixed on substrate 124. Light flux controlling member 200 is disposed over light emitting element 162 such that central axis CA thereof coincides with optical axis OA of light emitting element 162. Reflection surface 220 and emission surface 230 of later-described light flux controlling member 200 are both rotationally symmetric (circularly symmetric), and rotation axes thereof coincide with each other. The axes of reflection surface 220 and emission surface 230 are referred to as “central axis CA of the light flux controlling member.” Further, “optical axis OA of the light emitting element” means a center beam of a three-dimensional light flux from light emitting element 162.

Light flux controlling member 200 is formed by integral molding. The material of light flux controlling member 200 is not particularly limited as long as light with desired wavelength can pass therethrough. For example, the material of light flux controlling member 200 is a light-transmissive resin such as polymethylmethacrylate (PMMA), polycarbonate (PC) or epoxy resin (EP), or glass.

A main feature of surface light source device 100 according to the present embodiment lies in a configuration of light flux controlling member 200. Therefore, light flux controlling member 200 will be described in detail later.

Light diffusion member 140 is a plate-like member having light diffusivity, and allows light emitted from light emitting device 160 to pass therethrough while diffusing the light. Normally, the size of light diffusion member 140 is substantially the same as the size of a member to be irradiated such as a liquid crystal panel. For example, light diffusion member 140 is formed of a light-transmissive resin such as polymethylmethacrylate (PMMA), polycarbonate (PC), polystyrene (PS) or styrene-methylmethacrylate copolymer resin (MS). To confer light diffusivity, fine irregularities are formed on the surface of light diffusion member 140, or light diffusion elements such as beads are dispersed in light diffusion member 140.

In surface light source device 100 according to the present embodiment, light emitted from each light emitting element 162 is expanded by light flux controlling member 200 to illuminate a broad area of light diffusion member 140. The light emitted from each light flux controlling member 200 is diffused further by light diffusion member 140. As a result, surface light source device 100 according to the present embodiment can uniformly illuminate a planar member to be irradiated (e.g. liquid crystal panel).

(Configuration of Light Flux Controlling Member)

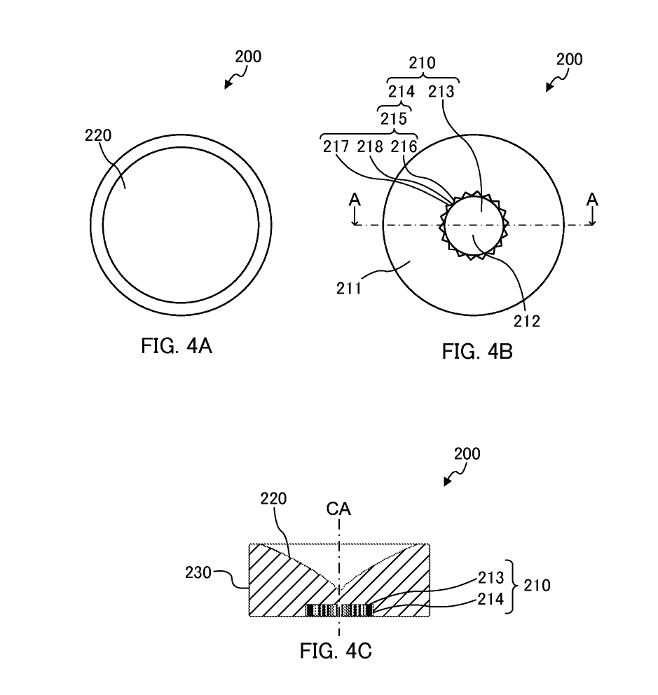

FIGS. 4A to 4C illustrate a configuration of light flux controlling member 200 according to the present embodiment. FIG. 4A is a plan view and FIG. 4B is a bottom view of light flux controlling member 200 according to the present embodiment, and FIG. 4C is a cross-sectional view taken along line A-A shown in FIG. 4B.

As illustrated in FIGS. 4A to 4C, light flux controlling member 200 includes rear surface 211, incidence surface 210, reflection surface 220 and emission surface 230.

Rear surface 211 is a flat surface disposed on the rear side of light flux controlling member 200. In the present embodiment, rear surface 211 is disposed perpendicular to central axis CA. Recess 212 is opened at the central portion of rear surface 211, and emission surface 230 is connected to the outer rim part of rear surface 211.

Incidence surface 210 is the inner surface of recess 212 opened at the central portion of rear surface 211. Incidence surface 210 allows light emitted from light emitting element 162 to be incident thereon. Specifically, incidence surface 210 refracts part of light emitted from light emitting element 162 toward reflection surface 220, or reflects another part of light emitted from light emitting element 162 and subsequently refracts the light toward the inside of light flux controlling member 200. Incidence surface 210 includes top surface 213 and side surface 214.

Top surface 213 is disposed so as to intersect central axis CA, and corresponds to the ceiling of recess 212. Top surface 213 may have any shape. Top surface 213 may be a flat surface, or may have a conical shaped part in the center portion. In the present embodiment, top surface 213 is a flat surface. Further, top surface 213 may have any plan-view shape.

Side surface 214 connects the outer rim part of top surface 213 with the opening edge of recess 212. Further, side surface 214 includes a plurality of linear protrusions 215.

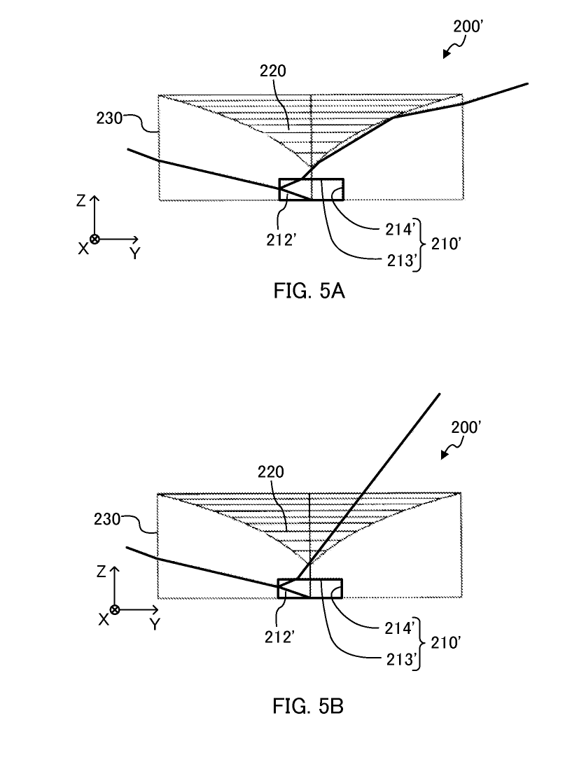

The length (height) of side surface 214 will be described using light flux controlling member 200′ that includes side surface 214′ having no linear protrusion 215 according to a comparative example (in which the shape of the incidence surface is different from that of light flux controlling member 200 according to the present embodiment). FIGS. 5A and 5B illustrate optical paths in light flux controlling member 200′ according to the comparative example. FIG. 5A illustrates optical paths in the case where side surface 214′ is long (the depth of recess 212′ is large, or the height of top surface 213′ is large, which will be described later), and FIG. 5B illustrates optical paths in the case where side surface 214′ is short (the depth of recess 212′ is small, or the height of top surface 213′ is small, which will be described later). Description will be made on the condition that, in each figure, the perpendicular direction on the sheet is referred to as Z axis direction and lateral direction as Y axis direction, and the direction orthogonal to the Z axis direction and Y axis direction is referred to as X axis direction. Further, the light emitting surface center of light emitting element 162 is assumed to be disposed on the origin of a three-dimensional orthogonal coordinate system, and central axis CA of light flux controlling member 200′ is assumed to coincide with Z axis.

In a cross-section including central axis CA, the length of side surface 214′ in the direction of central axis CA is preferably long enough to allow surface-reflected light by incidence surface 210′ disposed on one side of central axis CA (Z axis) to be totally reflected by reflection surface 220 disposed on the other side of central axis CA. As illustrated in FIG. 5A, in the case where the length of side surface 214′ in the direction of central axis CA (the depth of recess 212′) is large, light that is surface reflected by side surface 214′ and incident on top surface 213′ on one side of central axis CA (minus area in the Y axis direction) is reflected laterally by reflection surface 220 on the other side of central axis CA (plus area in the Y axis direction). On the other hand, as illustrated in FIG. 5B, in the case where the length of side surface 214′ in the direction of central axis CA (the depth of recess 212′) is small, light that is surface reflected by side surface 214′ reaches, at a small incident angle, reflection surface 220 disposed on the one side of central axis, (minus area in the Y axis direction) in a cross-section including central axis CA. Consequently, the light reached reflection surface 220 passes through reflection surface 220 and is emitted to a portion immediately above light flux controlling member 200 (see FIG. 5B).

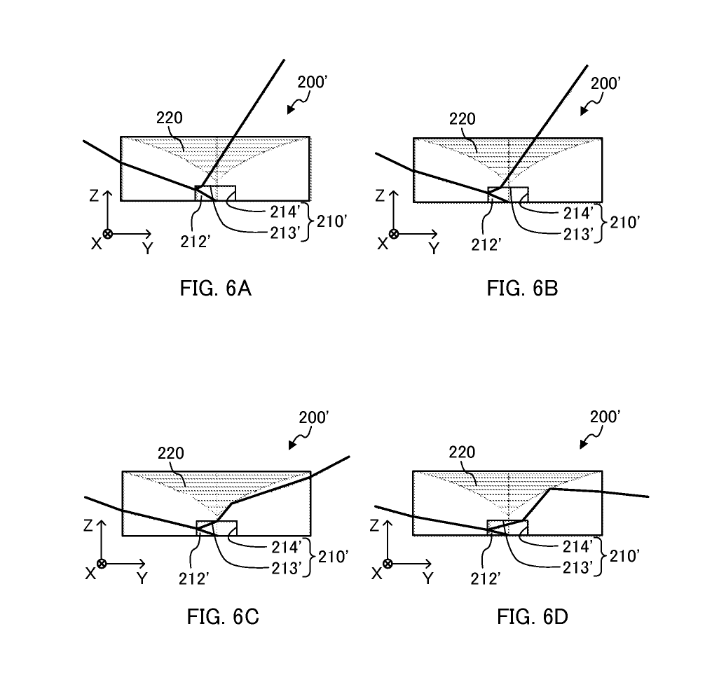

Next, a relationship will be described between an emission angle of light emitted from light emitting element 162 and an optical path in each light flux controlling member 200′ having the same shape including the length of side surface 214′. FIG. 6A illustrates an optical path in a case of light from light emitting element 162 at emission angle 60°, FIG. 6B at emission angle 65°, FIG. 6C at emission angle 70°, and FIG. 6D at emission angle 75°. As used herein, “emission angle” means an angle of emitted light when the angle of the optical axis direction (direction perpendicular to a light emitting surface of light emitting element 162) is zero degree.

As illustrated in FIGS. 6A and 6B, in a cross-section including central axis CA (optical axis OA of light emitted from light emitting element 162), light with emission angle 60° or 65°, which is surface reflected by side surface 214′ on one side of central axis CA and is incident on top surface 213′ on the one side (minus area in the Y axis direction) reached reflection surface 220 disposed on the same side (minus area in the Y axis direction). In this case, the light reached reflection surface 220 passes through reflection surface 220 and is emitted toward the outside of light flux controlling member 200′. On the other hand, as illustrated in FIGS. 6C and 6D, light which is surface reflected by side surface 214′ on the one side and is incident on top surface 213′ disposed on the other side (plus area in the Y axis direction) is likely to reach reflection surface 220 disposed on the same side (plus area in the Y axis direction) at an incident angle larger than the critical angle. In this case, the light reached reflection surface 220 is totally reflected by reflection surface 220 and subsequently emitted laterally from emission surface 230.

As described above, side surface 214 of light flux controlling member 200 according to the present embodiment includes a plurality of linear protrusion 215. Linear protrusions 215 allow light emitted from light emitting element 162 to pass therethrough or reflect the light so that the light deviates from central axis CA. Any number of linear protrusions 215 may be provided according to the size of side surface 214 or the light emitting surface of light emitting element 162. Also linear protrusions 215 may be disposed at any position on side surface 214. Linear protrusions 215 may be disposed on the whole side surface 214 or on the front side (top surface 213 side) of side surface 214. In the present embodiment, linear protrusions 215 are disposed on the whole side surface 214. The position on side surface 214 on which light emitted from light emitting element 162 is surface reflected (the position in the Y axis direction) and the position on top surface 213 from which the surface reflected light enters light flux controlling member 200 (the position in the Y axis direction) are on either sides with central axis CA as a center (plus area and minus area in the Y axis direction). With this configuration, light emitted from light emitting element 162 can be emitted laterally (see FIGS. 6C and 6D).

Linear protrusion 215 includes first inclining surface 216, second inclining surface 217 and ridge line 218. The cross-sectional shape of linear protrusion 215 orthogonal to central axis CA may be any shape as long as linear protrusion 215 has first inclining surface 216 and second inclining surface 217, and can exhibit the above described function. In the present embodiment, the cross-sectional shape orthogonal to central axis CA is a triangle. That is, ridge line 218 is formed between first inclining surface 216 and second inclining surface 217 in the present embodiment. The heights of linear protrusions 215 in a cross-section including central axis CA may be the same or different in the direction parallel to central axis CA. In the present embodiment, the heights of linear protrusions 215 in the cross-section including central axis CA are the same in the direction parallel to central axis CA.

First inclining surface 216 and second inclining surface 217 are disposed so as to form a pair. The angle between first inclining surface 216 and second inclining surface 217 is not particularly limited as long as the cross-sectional shape of side surface 214 orthogonal to central axis CA is not a circle. The relationship between light emitted from light emitting element 162 and the angle between first inclining surface and second inclining surface will be described later.

Ridge line 218 is an intersection line between first inclining surface 216 and second inclining surface 217, and extends from the outer rim part of top surface 213 to the opening edge of recess 212 so as to surround central axis CA. In the cross-section including central axis CA, the inclining angle of ridge line 218 relative to central axis CA is not particularly limited. Ridge line 218 may be disposed parallel to central axis CA, or may be disposed so that the distance from central axis CA decreases from the rear side to the front side of light flux controlling member 200. In the present embodiment, ridge line 218 is disposed parallel to central axis CA.

Reflection surface 220 laterally reflects light incident on incidence surface 210. Reflection surface 220 is a rotationally symmetrical (circularly symmetric) surface about central axis CA of light flux controlling member 200. The generatrix line of the rotationally symmetric surface from the center to the outer periphery is a recessed curve relative to light emitting element 162, and reflection surface 220 is a curved surface formed by rotating the generatrix line by 360° about central axis CA (see FIGS. 4A and 4C). That is, reflection surface 220 includes an aspherical curved surface whose height from light emitting element 162 increases in a direction from the center to the outer periphery. Further, the outer periphery of reflection surface 220 is formed at a position whose distance (height) from light emitting element 162 in the direction of optical axis OA of light emitting element 162 is larger than that of the center of reflection surface 220. For example, reflection surface 220 is an aspherical curved surface whose height from light emitting element 162 increases in a direction from the center to the outer periphery, or an aspherical curved surface whose height from light emitting element 162 (substrate 124) increases from the center to a predetermined position in a direction from the center to the outer periphery and then the height decreases from the predetermined position to the outer periphery in the same direction. In the former case, the inclining angle of reflection surface 220 relative to the surface direction of substrate 124 decreases in the direction from the center to the outer periphery. In the latter case, reflection surface 220 has a point located between the center and the outer periphery, and closer to the outer periphery; the inclining angle of the point relative to the surface direction of substrate 124 is zero degree (parallel to substrate 124). It is to be noted that, while the term “generatrix line” generally means a straight line that defines a ruled surface, the term “generatrix line” used herein includes curves for defining reflection surface 220 which is a rotationally symmetric surface.

Emission surface 230 is configured to emit light reflected by reflection surface 220 to the outside of light flux controlling member 200. Emission surface 230 is disposed so as to surround central axis CA. In the present embodiment, emission surface 230 is a curved surface along central axis CA. In a cross-section including central axis CA, the top of emission surface 230 is connected with reflection surface 220, and the bottom of emission surface 230 is connected with rear surface 211.

(Simulation)

To assess effects of linear protrusions 215 on the traveling direction of light emitted from light emitting element 162, simulations were carried out regarding the relationship between the traveling direction of light emitted from light emitting element 162 and an angle between first inclining surface 216 and second inclining surface 217. The simulations were carried out for 6 types of light flux controlling members 200 in which the angle between first inclining surface and second inclining surface is 40°, 60°, 90°, 110°, 120° or 160° (θ1 to θ6).

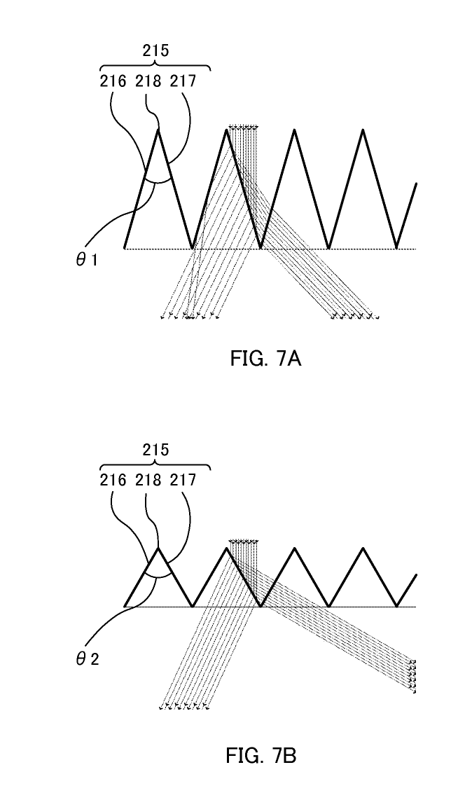

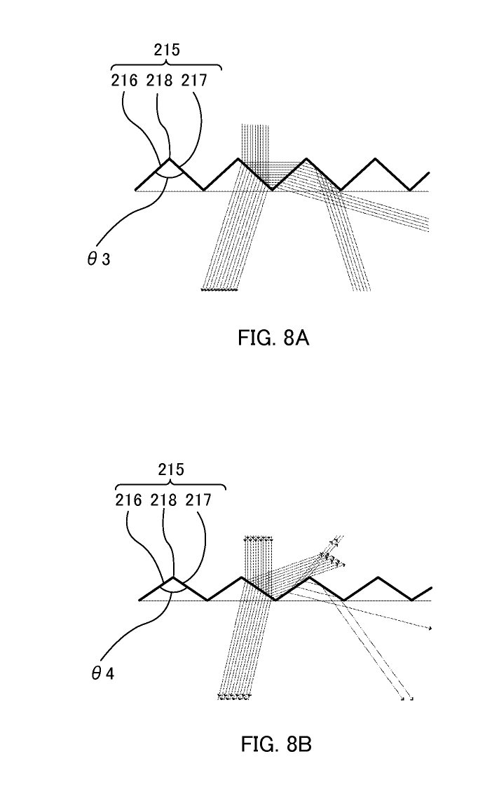

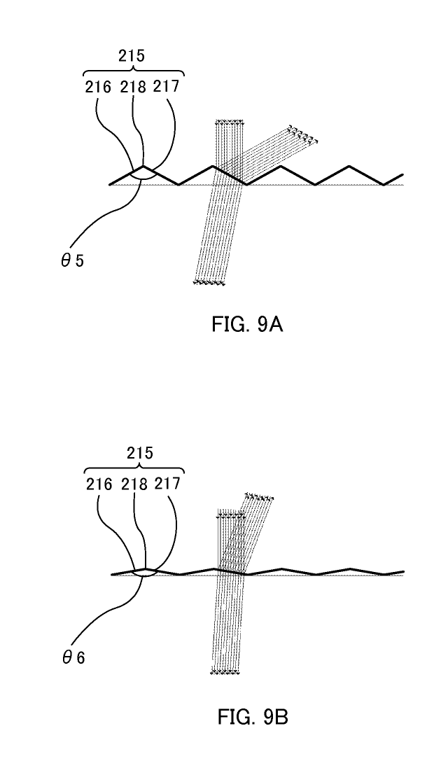

FIGS. 7A to 9B illustrate the simulations indicating the relationship between the traveling direction of light emitted from light emitting element 162 and the angle between first inclining surface 216 and second inclining surface 217 (θ1 to θ6). FIG. 7A is the simulation for angle 40° (θ1) between first inclining surface 216 and second inclining surface 217, FIG. 7B for angle 60° (θ2), FIG. 8A for angle 90° (θ3), FIG. 8B for angle 110° (θ4), FIG. 9A for angle 120° (θ5), and FIG. 9B for angle 160° (θ6). It is to be noted that, in FIGS. 7A to 9B, optical paths are viewed in a plan view, and three-dimensionally, light reflected by second inclining surface 217 would travel in the direction immediately above light flux controlling member 200.

As illustrated in FIGS. 7A, 7B and 8A, when angle θ1, θ2 or θ3 between first inclining surface 216 and second inclining surface 217 is 90° or less (FIG. 7A; 40°, FIG. 7B; 60°, and FIG. 8A; 90°), part of light reached second inclining surface 217 is refracted and enters the inside of light flux controlling member 200. Another part of the light reached second inclining surface 217 is reflected toward first inclining surface 216 of adjacent linear protrusion 215. The light reached first inclining surface 216 of adjacent linear protrusion enters the inside of light flux controlling member 200. As described above, when angle θ1, θ2 or θ3 between first inclining surface 216 and second inclining surface 217 is 90° or less, since little light reaches top surface 213 after reflected by second inclining surface 217, the amount of light traveling in the direction immediately above light flux controlling member 200 can be limited.

As illustrated in FIG. 8B, when angle θ4 between first inclining surface 216 and second inclining surface 217 is 110°, part of light reached second inclining surface 217 is refracted and enters the inside of light flux controlling member 200. Another part of the light reached second inclining surface 217 is reflected toward first inclining surface 216 of adjacent linear protrusion 215. Part of the light reached first inclining surface 216 of adjacent linear protrusion 215 enters the inside of light flux controlling member 200, and another part of the light reached first inclining surface 216 of adjacent linear protrusion 215 is reflected in the direction immediately above light flux controlling member 200. As described above, when angle θ4 between first inclining surface 216 and second inclining surface 217 is 110°, while part of light is surface reflected twice by second inclining surface 217 and first inclining surface 216 and travels in the direction immediately above light flux controlling member 200, light that is not surface reflected by first inclining surface 216 but enters the inside of light flux controlling member 200 also exists. It is to be noted that, while the light reflected by first inclining surface 216 of adjacent linear protrusion 215 is drawn in FIG. 8B, light reflected by first inclining surface 216 of adjacent linear protrusion 215 is not drawn in FIG. 8A. This is because when θ3 is 90° (FIG. 8A), the surface reflectivity on first inclining surface 216 is small in the case of the incident angle of the light surface reflected by second inclining surface 217, and therefore the amount of the reflected light is small.

As illustrated in FIGS. 9A, and 9B, when angle θ5 or θ6 between first inclining surface 216 and second inclining surface 217 is 120° or more (FIG. 9A; 120° and FIG. 9B; 160°), part of light reached second inclining surface 217 is refracted and enters the inside of light flux controlling member 200. Another part of the light reached second inclining surface 217 is reflected. At this time, the light reflected by second inclining surface 217 is reflected so as to deviate from central axis CA, and therefore, the formation of a bright part in a portion immediately above light flux controlling member 200 can be suppressed.

As described above, light emitted from light emitting element 162, which reaches first inclining surface 216 and second inclining surface 217 of linear protrusions 215, is surface reflected and travels in a direction different from the optical path illustrated in FIG. 5B, and therefore the light does not travel to the portion immediately above light flux controlling member 200. Further, it is preferable that the angle between first inclining surface 216 and second inclining surface 217 be less than 120° because in this case, light reflected by first inclining surface 216 or second inclining surface 217 directly enters the inside of light flux controlling member 200 from adjacent linear protrusion 215, so that the surface reflected light does not require a long optical path to enter light flux controlling member 200 and optical loss can be suppressed.

Next, in light flux controlling member 200 of the present embodiment, a simulation of optical paths of light incident on linear protrusions 215 was carried out. For comparison, in a light flux controlling member having no linear protrusion 215 (hereinafter referred to as “light flux controlling member according to a comparative example”), a similar simulation was carried out. The angle of light emitted from the light emitting surface of light emitting element 162 relative to central axis CA was set 70°.

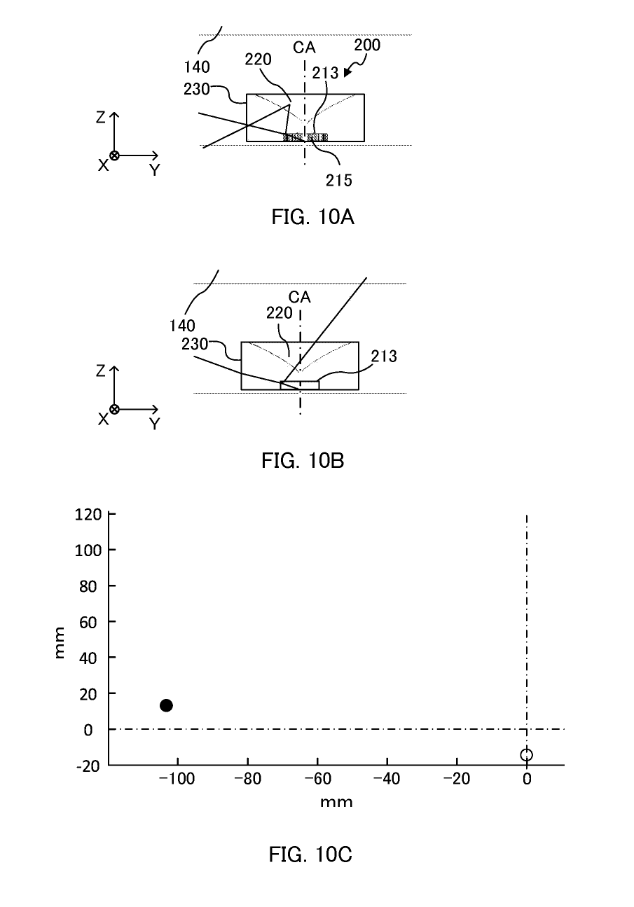

FIG. 10A illustrates optical paths of light emitted from the center of the light emitting surface of light emitting element 162 in light flux controlling member 200 according to the present embodiment, and FIG. 10B illustrates optical paths of light emitted from the center of the light emitting surface of light emitting element 162 in the light flux controlling member according to the comparative example. FIG. 10C illustrates plotted arrival positions of light reflected by incidence surface 210, which is part of light emitted from light emitting element 162, on light diffusion member 140. The ordinate and abscissa in FIG. 10C represent the distance (mm) from the center of the light flux controlling member. Also, the abscissa corresponds to the X direction shown in FIGS. 10A and 10B, and the ordinate corresponds to Y direction. The closed circle symbol represents the result of light flux controlling member 200 according to the present embodiment, and the open circle symbol represents the result of the light flux controlling member according to the comparative example.

As shown in FIG. 10A and as the closed circle symbol in FIG. 10C, in light flux controlling member 200 according to the present embodiment, part of light emitted from the center of light emitting element 162 is incident on or reflected by linear protrusion(s) 215 (first inclining surface 216 and/or second inclining surface 217). On the one hand, the light incident on linear protrusion 215 is emitted from emission surface 230 without being reflected. On the other hand, the light reflected by linear protrusion 215 is incident on top surface 213 and reflected by reflection surface 220. Subsequently, the light reflected by reflection surface 220 does not travel in the direction immediately above light flux controlling member 200, but is emitted laterally.

As shown in FIG. 10B and as the open circle symbol in FIG. 10C, in the light flux controlling member according to the comparative example, part of light emitted from the center of the light emitting element 162 is incident on or reflected by side surface 214. On the one hand, the light incident on side surface 214 is emitted from emission surface 230 without being reflected. On the other hand, the light reflected by side surface 214 passes through reflection surface 220 and travels in the direction immediately above light flux controlling member 200.

(Effect)

As described above, in light flux controlling member 200 according to the present embodiment, the formation of a bright part in a portion immediately above light flux controlling member 200 can be suppressed because linear protrusions 215 disposed on side surface 214 of the incidence surface can change the traveling direction of light surface reflected by side surface 214. Therefore, luminance unevenness on surface light source device 100 can be reduced by using light flux controlling member 200 according to the present embodiment.

### INDUSTRIAL APPLICABILITY

The light flux controlling member, light emitting device and surface light source device according to the present invention may be employed in a backlight of a liquid crystal display apparatus or general lighting.

### REFERENCE SIGNS LIST

100 surface light source device
120 casing
122 bottom plate
124 substrate
140 light diffusion member
160 light emitting device
162 light emitting element
200, 200′ light flux controlling member
210 incidence surface
211 rear surface
212, 212′ recess
213, 213′ top surface
214, 214′ side surface
215 linear protrusion
216 first inclining surface
217 second inclining surface
218 ridge line
220 reflection surface
230 emission surface
CA central axis
OA optical axis

1. A light flux controlling member configured to control a distribution of light emitted from a light emitting element, the light flux controlling member comprising:
a rear surface disposed on a rear side of the light flux controlling member;
an incidence surface configured such that light emitted from the light emitting element is incident on the incidence surface, the incidence surface being an inner surface of a recess opened at the rear surface to intersect a central axis of the light flux controlling member;
a reflection surface configured to laterally reflect part of the light incident on the incidence surface, the reflection surface being disposed on a front side of the light flux controlling member so that a distance from the light emitting element to the reflection surface increases in a direction from a center to an outer periphery of the reflection surface; and
an emission surface configured to emit the light reflected by the reflection surface, the emission surface being disposed to surround the central axis;
wherein the incidence surface comprises:
a top surface disposed in the recess to intersect the central axis, and
a side surface connecting an outer rim part of the top surface with an opening edge of the recess,
wherein the side surface comprises:
a plurality of linear protrusions each including a ridge line extending from the outer rim part of the top surface to the opening edge of the recess.

2. The light flux controlling member according to claim 1, wherein the linear protrusions are disposed on a whole of the side surface.

3. The light flux controlling member according to claim 1,
wherein each linear protrusion comprises:
a first inclining surface;
a second inclining surface disposed to form a pair with the first inclining surface; and
the ridge line that is an intersection line between the first inclining surface and second inclining surface,
wherein an angle between the first inclining surface and second inclining surface is less than 120°.

4. A light emitting device comprising:
a light emitting element and the light flux controlling member according to claim 1,
wherein the light flux controlling member is disposed such that the central axis coincides with an optical axis of the light emitting element.

5. A surface light source device comprising:
the light emitting device according to claim 4; and
a light diffusion member configured to allow light emitted from the light emitting device to pass through the light diffusion member while diffusing the light.

6. A display apparatus comprising:
the surface light source device according to claim 5; and
a display member configured such that light emitted from the surface light source device is radiated to the display member.

7. The light flux controlling member according to claim 2,
wherein the linear protrusion comprises:
a first inclining surface;
a second inclining surface disposed so as to form a pair with the first inclining surface; and
the ridge line that is an intersection line between the first inclining surface and second inclining surface,
wherein an angle between the first inclining surface and second inclining surface is less than 120°.

8. A light emitting device comprising:
a light emitting element and the light flux controlling member according to claim 2,
wherein the light flux controlling member is disposed such that the central axis coincides with an optical axis of the light emitting element.

9. A light emitting device comprising:
a light emitting element and the light flux controlling member according to claim 3,
wherein the light flux controlling member is disposed such that the central axis coincides with an optical axis of the light emitting element.

10. A light emitting device comprising:
a light emitting element and the light flux controlling member according to claim 7,
wherein the light flux controlling member is disposed such that the central axis coincides with an optical axis of the light emitting element.

11. A surface light source device comprising:
the light emitting device according to claim 8, and
a light diffusion member configured to allow light emitted from the light emitting device to pass through the light diffusion member while diffusing the light.

12. A surface light source device comprising:
the light emitting device according to claim 9; and
a light diffusion member configured to allow light emitted from the light emitting device to pass through the light diffusion member while diffusing the light.

13. A surface light source device comprising:
the light emitting device according to claim 10; and
a light diffusion member configured to allow light emitted from the light emitting device to pass through the light diffusion member while diffusing the light.

14. A display apparatus comprising:
the surface light source device according to claim 11; and
a display member configured such that light emitted from the surface light source device is radiated to the display member.

15. A display apparatus comprising:
the surface light source device according to claim 12; and
a display member configured such that light emitted from the surface light source device is radiated to the display member.

16. A display apparatus comprising:
the surface light source device according to claim 13; and
a display member configured such that light emitted from the surface light source device is radiated to the display member.
